(19) United States
(12) Patent Application Publication
(10) Pub. No.: US 2009/0274057 A1
(43) Pub. Date: Nov. 5, 2009

(54) Systems, Methods and Software for Identifying a Preferred Egress Gateway in a Bypass Network for Accessing a Content Server in Another Network

(76) Inventors: Darrell Genrty, Mountain View, CA (US); Nathan Burns, San Francisco, CA (US)

Correspondence Address: HARNESS, DICKEY, & PIERCE, P.L.C, 7700 Bonhomme, Suite 400, ST. LOUIS, MO, 63105, US

(21) Appl. No.: 12/325,802

(22) Filed: Dec. 1, 2008

Related U.S. Application Data
(60) Provisional application No. 60/991,298, filed on Nov. 30, 2007.

(51) Int. Cl. H04L 12/26

(52) U.S. Cl. 370/252

(57) ABSTRACT

A bypass computer network has multiple egress gateways for communicating with one or more content servers in other computer network(s). The bypass network is configured to test the performance between each egress gateway and a content server, and to identify at least one preferred egress gateway for accessing the content server based on the testing. The preferred egress gateway may perform Network Address Translation to translate the source IP address of a client seeking data from the content server to a publicly addressable IP assigned to the preferred egress gateway.

### CROSS REFERENCE TO RELATED APPLICATION

This application claims the benefit of U.S. Provisional Application No. 60/991,298 filed Nov. 30, 2007, the entire disclosure of which is incorporated herein by reference.

The present disclosure relates to improving performance of a bypass computer network. In some embodiments, the bypass network is a private Internet Protocol (IP) communications network comprising nodes in two or more geographic locations (e.g., in different cities or States) interconnected by private IP communication links. Each node preferably includes an ingress gateway (for entering the bypass network) and an egress gateway (for exiting the bypass network) that are connected to the private IP communications network and also connected to other private or public network(s), such as the public Internet. Clients of the bypass network may connect to (and receive data back from) the ingress gateways using a tunneling protocol (to establish a virtual connection through a physical connection) such as Internet protocol 4 (also referred to as “ipencap” or “IP within IP tunneling”) or other suitable means. These connections allow client data to transit the bypass network. Egress gateways are used when the destination end of the IP communication conversation (e.g., a computer server) is not a client of the bypass network. In that event, traffic is directed from the bypass network to another computer network, such as the public Internet, through the egress gateways (and preferably through the egress gateway positioned closest to the content server) via peering connections between the egress gateways and network routers. The egress gateways may use Network Address Translation (NAT) to provide a return path from the non-bypass computer network (e.g., the Internet) back to the same egress gateway and subsequently through the bypass network back to the originating client. The egress gateways may also use state-full packet inspection to ensure that only outgoing IP conversations are taking place, i.e., that the packets received back by the egress gateway are in response to conversations which originated on the bypass network.

Each client computing device has a physical connection to a data network (e.g., to a network access provider, such as an Internet Service Provider (ISP)). The ingress gateways can work cooperatively with software installed on the client computing devices. The software may be a simple tunneling program to direct traffic to the ingress gateway, or may be an intelligent dynamic or non-dynamic routing program that decides whether and when to use the bypass network for accessing a remote content server (e.g., based on a user selection, user-specified rules, the type of data to be transmitted, the intended data destination, latency to destination, etc.).

The bypass network can have its own physical infrastructure, or it can be a virtual private network operating on the physical infrastructure of one or more other networks, such as the Internet, or it can be a combined physical and virtual network.

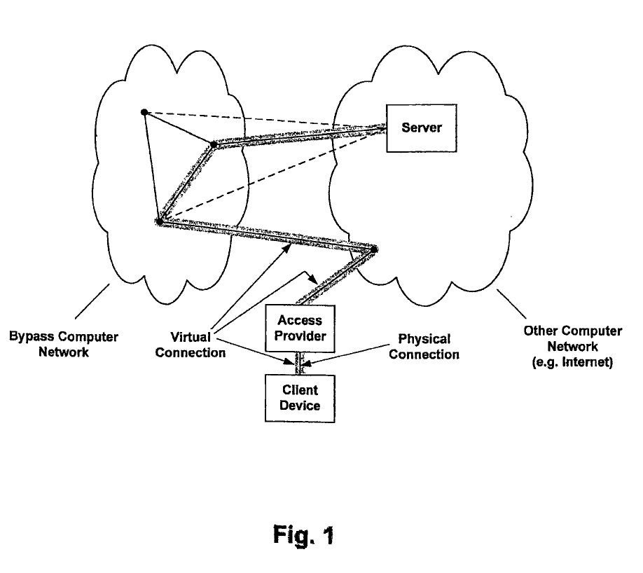

FIG. 1 illustrates one example of a client computing device using a physical connection to a network access provider (e.g., an ISP) to establish a virtual connection to a bypass network. As shown in FIG. 1, the bypass network can receive, via the virtual connection, a data request seeking content from a server residing on another computer network, which may be the Internet. The bypass network routes the data request to the server through a portion of the bypass network and through a portion of the other network (as indicated by the gray line in FIG. 1). The same data path may be and preferably is used for providing the requested data from the server back to the client. While the bypass network is illustrated as a physically distinct network in FIG. 1, it should be understood that the bypass network may be, at least in part, a virtual network operating on the physical infrastructure of one or more other networks, such as the other computer network shown in FIG. 1.

By using the bypass network to route around a portion of the Internet (or other computer network(s)), a client can minimize the data transit path through the Internet (or other computer network(s)) for improved performance (e.g., reduced latency, jitter, etc.) or a more reliable or consistent data communication experience (e.g., more consistent ping times, reduced number of hops between the client and a content server, etc.).

The bypass network preferably includes software configured to test the performance between each of multiple egress gateways and a content server, and to identify at least one preferred egress gateway for accessing the content server based on the testing. For example, FIG. 1 illustrates a bypass computer network having three nodes, each of which is capable of accessing the server residing on the other network (as indicated by the dashed and solid lines between the nodes and the server). Before establishing a connection with the client, the bypass network tests the performance between each node and the server, and identifies one of the nodes as a preferred node for accessing the server (the preferred node in FIG. 1 has a solid line between it and the server). Subsequently, when the bypass network receives from a client a request for data from the server, the bypass network routes the data request to the preferred node for accessing the server, as shown in FIG. 1.

In some embodiments, the software includes a testing module, a main module, a route manipulation module, and a network routing table interconnection module. In operation, a client computing device may request data, via the bypass network, from a content server that does not reside within the bypass network. The main module of the software captures the network address of the targeted content server. The main module then polls each egress gateway of the bypass network to identify those egress gateways through which the targeted content server can be accessed. Once potential egress gateways are identified, the testing module initiates a test from each identified egress gateway capable of accessing the content server. The testing may include, for example, determining latency between a given egress gateway and the content server, determining the number of routers (and therefore the number of routing decisions) between a given egress gateway and the content server, determining the physical proximity of a given egress gateway to the content server, etc. The testing module provides the testing data to the main module. Based on this testing data, and possibly pre-defined network preferences as well, the main module designates one of the egress gateways as the preferred egress gateway for accessing the content server. In many cases, this preferred egress gateway will be the egress gateway with the most direct route to the content server. The main module then causes the route manipulation module to populate the internal routing tables of the bypass network with the preferred egress gateway for accessing such content server.

In some embodiments, only one preferred egress gateway is designated for accessing, from within the bypass network, a particular content server in another network (such as the Internet). In other embodiments, multiple preferred egress gateways can be designated for accessing a particular content server in another network, with each preferred egress gateway serving a particular group of clients of the bypass network, or a particular group of ingress gateways. This is because one egress gateway may have the best performance (e.g., the most direct route) for accessing the content server with respect to some but not all bypass network clients and/or ingress gateways.

As noted above, the preferred egress gateway(s) can be designated based on the testing data and pre-defined network preferences. For example, the pre-defined network preferences may indicate that the egress gateway with the lowest latency to a defined content server should be designated a preferred egress gateway. The pre-defined network preferences may also indicate, for example, that if the latencies from multiple egress gateways to a defined content server are equivalent, the egress gateway with the fewest number of routers between it and the defined content server should be designated the preferred egress gateway. The internal gateway protocol of the bypass network will assign internal routes to ingress and egress gateways based on the testing and the pre-defined network preferences.

The teachings of this disclosure can be applied, for example, to on-line video gaming applications in which clients communicate with remote video game servers (e.g., in different cities and/or states than the client) over a portion of the Internet. It should be understood, however, that the teachings of this disclosure are not so limited and can be applied to a wide variety of data communication applications.

The above description should be construed as exemplary only and does not describe every possible instance of the system. Numerous alternatives could be implemented, using combinations of current or future technologies, which would still fall within the scope of the claims. As just one example, the bypass network may be a public (rather than private) computer network.

1. A method of using a bypass network to route data to a content server residing in another computer network, the bypass network having a plurality of egress gateways capable of accessing the content server, the method comprising:
testing performance between each egress gateway and the content server; and
identifying at least one preferred egress gateway for accessing the content server based on the testing.

2. The method of claim 1 further comprising using the preferred egress gateway for accessing the content server in response to requests for data from the content server.

3. The method of claim 2 wherein using includes performing network address translation at the preferred egress gateway for routing data to and from the content server.

4. The method of claim 2 further comprising receiving said requests for data from clients of the bypass network.

5. The method of claim 1 wherein identifying includes identifying a first preferred egress gateway for accessing the content server on behalf of a first group of ingress gateways of the bypass network, and identifying a second preferred egress gateway for accessing the content server on behalf of a second group of ingress gateways of the bypass network.

6. The method of claim 5 wherein the first group of ingress gateways are located in a first geographic region and the second group of ingress gateways are located in a second geographic region remote from the first geographic region.

7. The method of claim 1 wherein identifying includes identifying at least one preferred egress gateway for accessing the content server based on the testing and pre-defined settings.

8. The method of claim 1 further comprising identifying the content server prior to the testing.

9. The method of claim 1 further comprising identifying the plurality of egress gateways capable of accessing the content server.

10. The method of claim 1 further comprising populating routing tables in the bypass network with data identifying the preferred egress gateway for accessing the content server.

11. A computer-readable medium having computer-executable instructions for performing the method of claim 1.

12. A computer system having one or more computer-readable mediums having computer-executable instructions including a testing module, a main module, a route manipulation module and a network routing table interconnection module which cooperatively allow the identification of a preferred or optimum egress gateway in a bypass network for accessing a content server residing in another computer network.

13. (canceled)
